(19) United States
(12) Patent Application Publication
(10) Pub. No.: US 2025/0300299 A1
(43) Pub. Date: Sep. 25, 2025

(54) BATTERY MODULE

(71) Applicant: HONDA MOTOR CO., LTD., Tokyo (JP)

(72) Inventor: Wataru Ohira, Wako-shi (JP)

(21) Appl. No.: 19/081,370

(22) Filed: Mar. 17, 2025

(30) Foreign Application Priority Data
Mar. 22, 2024 (JP) 2024-046648

(51) Int. Cl. H01M 50/264; H01M 10/613; H01M 10/647; H01M 10/6569; H01M 50/209

(52) U.S. Cl. CPC H01M 50/264; H01M 10/613; H01M 10/647; H01M 10/6569; H01M 50/209

(57) ABSTRACT

A battery module includes a cell stack that includes battery cells and heat exchangers, a holding mechanism that holds the cell stack by pressing both stacking-direction end portions of the cell stack inward in the stacking direction, and a fall-off prevention mechanism that prevents at least the heat exchangers from falling off the cell stack.

### CROSS-REFERENCE TO RELATED APPLICATIONS

This application is based upon and claims the benefit of priority from Japanese Patent Application No. 2024-046648 filed on Mar. 22, 2024, the contents of which are incorporated herein by reference.

### BACKGROUND OF THE INVENTION

### Field of the Invention

The present disclosure relates to a battery module.

### Description of the Related Art

JP 2023-101130 A discloses a battery module including a cell stack formed by stacking battery cells and heat exchangers. The battery module further includes a holding mechanism (battery frame) that holds the cell stack by applying a tightening load from both sides of the cell stack. The battery frame prevents movement of the battery cells and the heat exchangers.

### SUMMARY OF THE INVENTION

The cell stack is held by only a frictional force caused by a pressing force applied from the battery frame. Therefore, when a force exceeding a holding force caused by the frictional force acts on the cell stack at the time of occurrence of an impact such as vibration, the movement (displacement) of the heat exchangers or battery cells in the direction orthogonal to the stacking direction may occur. As a countermeasure, there is a method to improve the pressing force (tightening force) by the battery frame. However, the above measures require the rigidity of the battery cells and heat exchangers to be increased. In addition, there is concern that the above countermeasure will increase the tightening force acting on the battery cells when expansion occurs due to heat generation or degradation of the battery cells.

The present disclosure aims to solve the aforementioned problems.

An aspect of the present disclosure is a battery module including a cell stack that includes a battery cell and a heat exchanger stacked on the battery cell, a holding mechanism that holds the cell stack by pressing both stacking-direction end portions of the cell stack inward in a stacking direction, and a fall-off prevention mechanism that prevents at least the heat exchanger from falling off from the cell stack.

According to the present disclosure, the heat exchangers are supported by the fall prevention mechanism even when an impact beyond anticipation is applied to the battery module. This prevents the heat exchangers from falling off the cell stack. In addition, because it is not necessary to increase the tightening force exerted by the holding mechanism, the tightening force acting on the battery cell can be prevented from becoming too large when the battery cell expands because of heat generation or deterioration of the battery cell.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a battery module according to an embodiment of the present disclosure;

FIG. 2 is an exploded perspective view of a cell stack;

FIG. 3 is a schematic cross-sectional view taken along a line III-III of FIG. 1;

FIG. 4 is a schematic cross-sectional view of a fall-off prevention mechanism;

FIG. 5A is a schematic cross-sectional view taken along a VA-VA line of FIG. 4; FIG. 5B is a schematic cross-sectional view of a state where the heat exchanger is supported by the fall-off prevention mechanism; and

FIG. 6 is a schematic diagram of an aircraft in which the battery module is mounted.

### DETAILED DESCRIPTION OF THE INVENTION

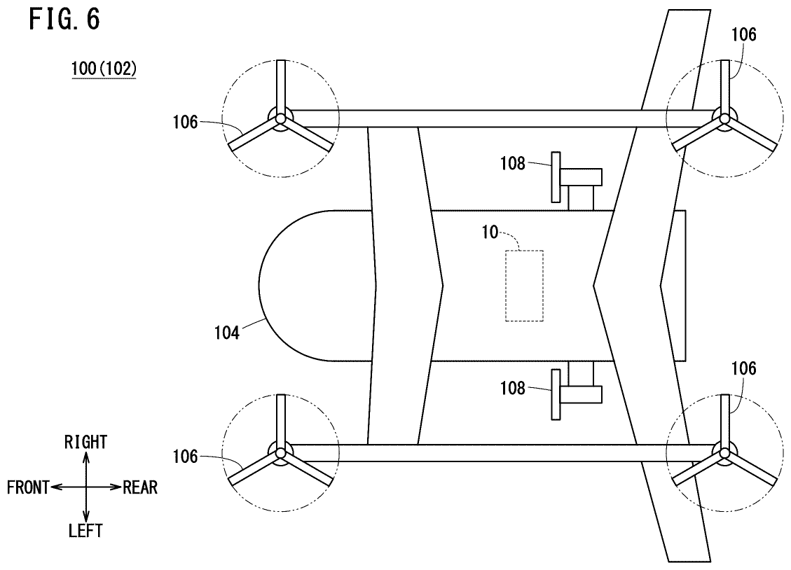

As shown in FIG. 6, a battery module 10 according to a present embodiment is mounted in, for example, an aircraft 102 as a mobile object 100. The aircraft 102 is, for example, an electric vertical take-off and landing (eVTOL) aircraft. The aircraft 102 includes a fuselage 104, multiple (for example, four) VTOL rotors 106, and multiple (for example, two) cruise rotors 108.

The VTOL rotor 106 generates an upward thrust force with respect to the aircraft 102. The cruise rotor 108 generates a horizontal thrust force with respect to the aircraft 102. The battery module 10 is placed inside the fuselage 104. The battery module 10 supplies power to an electric motor (not shown) that drives each of the VTOL rotors 106 and the cruise rotors 108. The mobile object 100 may also be, for example, a vehicle, a ship, or the like. The battery module 10 is not limited to the example where the battery module 10 is mounted in the mobile object 100.

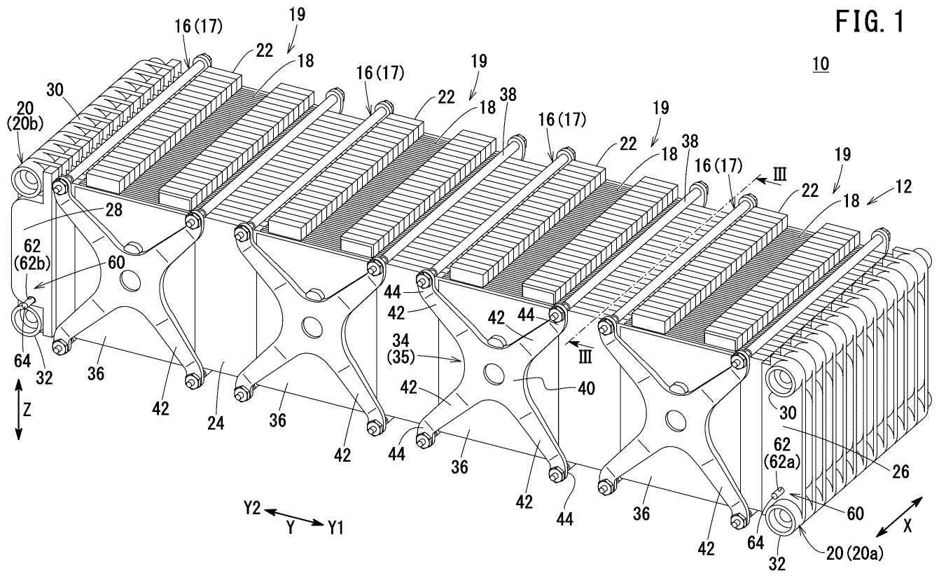

As shown in FIG. 1, the battery module 10 includes a cell stack 12 and a plurality of battery frames 16.

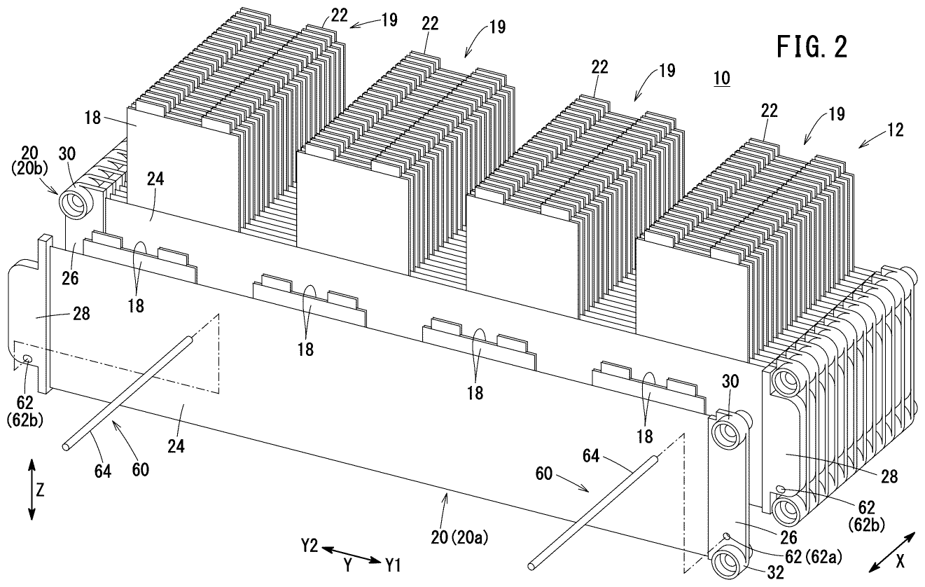

As shown in FIG. 2, the cell stack 12 includes a plurality of battery cells 18 and a plurality of heat exchangers 20. A single cell row 19 is formed of a plurality of battery cells 18 arranged in the direction of the arrow X. In this embodiment, four cell rows 19 are arranged in the direction of the arrow Y. The number of cell rows 19 may be three or less, or four or more. Only one cell row 19 may be provided in the battery module 10. The battery cells 18 and the heat exchangers 20 are arranged (stacked) in the direction of the arrow X. In the following, the X direction is also referred to as “stacking direction”. In addition, the direction toward the center of the battery module 10 in the X direction is expressed as “inward in the stacking direction”. The direction away from the center of the battery module 10 in the X direction is expressed as “outward in the stacking direction”.

The battery cell 18 is a laminate type battery. The battery cell 18 is formed in a rectangular plate shape. A plurality of terminal portions 22 project from one side of the battery cell 18, the side being in the direction of the arrow Z. The battery cells 18 are connected in series with each other via the terminal portions 22. The terminal portions 22 are conceptually illustrated. Electrical connecting members (not shown) are bonded to the terminal portions 22.

The heat exchangers 20 include a plurality of first heat exchangers 20a and a plurality of second heat exchangers 20b. As shown in FIG. 2, each first heat exchanger 20a has a plate-like water jacket 24, a water supply-drainage header 26, and a turn header 28. The water jacket 24 extends in the direction of the arrow Y. A flow path through which cooling water circulates is formed in the water jacket 24. Although not shown in detail, this flow path has a forward flow path for letting cooling water flow from the water supply-drainage header 26 toward the turn header 28 and a return flow path for letting cooling water flow from the turn header 28 toward the water supply-drainage header 26.

The water supply-drainage header 26 is one of a pair of headers provided in the first heat exchanger 20a. The water supply-drainage header 26 is provided at a first end portion, which is one end portion (Y1 direction side) in the longitudinal direction (direction of the arrow Y) of the water jacket 24. The water supply-drainage header 26 supplies cooling water to and discharges cooling water from the water jacket 24. The water supply-drainage header 26 has a water supply port 30 and a water drain port 32. The water supply port 30 is provided on an upper portion of the water supply-drainage header 26. The water supply port 30 supplies cooling water to the forward flow path of the water jacket 24. The water supply ports 30 of the first heat exchangers 20a adjacent to each other are connected liquid-tightly to each other.

The drain port 32 discharges the cooling water from the return flow path of the water jacket 24. The drain port 32 is provided at a lower portion of the water supply-drainage header 26. The drain ports 32 of the first heat exchangers 20a adjacent to each other are connected liquid-tightly to each other. Contrary to the above configuration, the water supply port 30 may be provided at the lower portion of the water supply-drainage header 26, and the water drain port 32 may be provided at the upper portion of the water supply-drainage header 26.

Although the details are not illustrated, the water supply ports 30 of the first heat exchangers 20a adjacent to each other are connected to be relatively movable in the X direction so that the expansion of the battery cells 18 in the X direction caused by heat generation or deterioration of the battery cells 18 can be absorbed. Similarly, the drain ports 32 of the first heat exchangers 20a adjacent to each other are connected to each other to be relatively movable in the X direction.

The turn header 28 is the other of a pair of headers provided in the first heat exchanger 20a. The turn header 28 is provided at the second end portion, which is the other end portion (Y2 direction side) in the longitudinal direction of the water jacket 24. For this reason, the water jacket 24 is arranged between the water supply-drainage header 26 and the turn header 28. The turn header 28 receives cooling water from the forward flow path of the water jacket 24 and lets the cooling water flow to the return flow path of the water jacket 24.

The second heat exchanger 20b has a water jacket 24, a water supply-drainage header 26, and a turn header 28, as the first heat exchanger 20a. However, the second heat exchanger 20b is arranged in a different direction from the first heat exchanger 20a in the Y-direction. Therefore, in the case of the second heat exchanger 20b, the water supply-drainage header 26 is arranged on the Y2 direction side of the water jacket 24, and the turn header 28 is arranged on the Y1 direction side of the water jacket 24.

The first heat exchanger 20a and the second heat exchanger 20b are alternately arranged in the direction of the arrow X. Thus, the water supply-drainage header 26 of one of the first heat exchanger 20a and the second heat exchanger 20b and the turn header 28 of the other of the first heat exchanger 20a and the second heat exchanger 20b are adjacent to each other in the stacking direction (X direction).

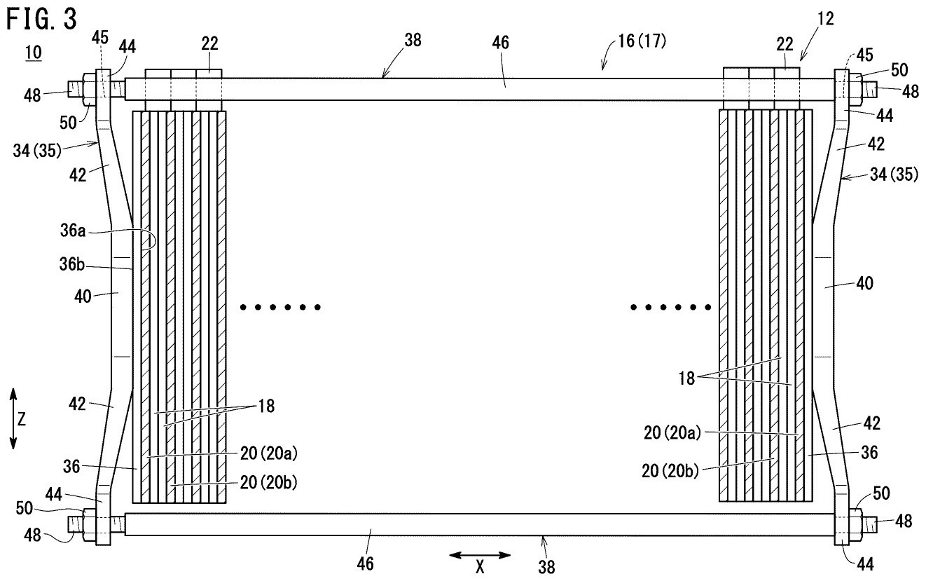

As shown in FIG. 3, two battery cells 18 are stacked in the direction of the arrow X between the first heat exchanger 20a and the second heat exchanger 20b that are adjacent to each other.

As shown in FIG. 1, in this embodiment, four battery frames 16 are provided corresponding to the four cell rows 19. The number of battery frames 16 may be three or less or five or more depending on the number of cell rows 19. As shown in FIGS. 1 and 3, the battery frame 16 is a holding mechanism 17 that holds the cell stack 12. The battery frame 16 includes a pair of holding plates 34, a pair of pressure receiving plates 36, and four connecting members 38. The pair of holding plates 34 are placed at the end portions of the battery module 10 in the direction of the arrow X.

The holding plate 34 is a pressing portion 35 that presses the cell stack 12 in the stacking direction via the pressure receiving plate 36. The pressure receiving plate 36 is placed between the holding plate 34 and the cell stack 12. The connecting members 38 connect the pair of holding plates 34 to each other in such a way that the tightening load (compressive load) is applied from the pair of holding plates 34 to the cell stack 12. This suppresses expansion of the battery cell 18.

The pair of holding plates 34 are located outward in the stacking direction of the battery cells 18. The holding plate 34 is made of, for example, titanium alloy. The holding plate 34 may be made of a metal material other than titanium alloy.

As shown in FIG. 1, the holding plate 34 is formed in an X-shape when viewed from the thickness direction (the direction of the arrow X) of the holding plate 34. The holding plate 34 has a point-symmetric shape. The holding plate 34 includes a plate central portion 40 and four arm portions 42.

The plate central portion 40 is placed at a central portion of the holding plate 34. The four arm portions 42 extend radially from the plate central portion 40. The four arm portions 42 are provided at equal intervals in the circumferential direction of the plate central portion 40. The arm portion 42 is a leaf spring portion that is elastically deformed when a tightening load is applied to the cell stack 12. The number of arm portions 42 is not limited to four but may be three or five or more.

An attachment portion 44 is provided at an end portion in the extending direction of the arm portion 42. The connecting members 38 are connected to the attachment portion 44. The attachment portion 44 is formed with an insertion hole 45 through which a bolt portion 48 of the connecting member 38 is inserted (see FIG. 3).

The attachment portion 44 is located more outward than the cell stack 12 when viewed from the stacking direction (the direction of the arrow X) of the battery cells 18. The attachment portion 44 does not overlap with the terminal portion 22 when viewed from the direction of the arrow X.

The pressure receiving plate 36 is a pressing plate for evenly applying to the cell stack 12 the tightening load exerted from the holding plate 34. The pressure receiving plate 36 is formed in a quadrilateral shape. As shown in FIG. 3, a first surface 36a of the pressure receiving plate 36 facing the cell stack 12 is in surface contact with an end surface of the cell stack 12. A second surface 36b of the pressure receiving plate 36 facing in the direction opposite to the cell stack 12 is in surface contact with the plate central portion 40 of the holding plate 34. The battery frame 16 may omit the pressure receiving plate 36.

As shown in FIG. 1, with the holding plate 34 being attached to the pressure receiving plate 36, the four arm portions 42 extend, overlapping respectively with four corner portions of the pressure receiving plate 36 when viewed in the direction of the arrow X. With the holding plate 34 being attached to the pressure receiving plate 36, a gap is provided between the arm portion 42 and the corner portions of the pressure receiving plate 36. With the holding plate 34 being attached to the pressure receiving plate 36, the four attachment portions 44 are located more outward than the pressure receiving plate 36 when viewed in the direction of the arrow X.

As shown in FIG. 3, the connecting member 38 includes a connecting shaft 46, two bolt portions 48, and two nuts 50. The connecting shaft 46 extends along the stacking direction of the battery cells 18. The connecting shaft 46 is made of, for example, a metallic material, such as stainless steel. The bolt portion 48 protrudes from an axial end face of the connecting shaft 46. The bolt portion 48 is inserted through the insertion hole 45 of the attachment portion 44. The nut 50 is screwed into the bolt portion 48. The attachment portion 44 is located between the nut 50 and the connecting shaft 46.

When the nut 50 is tightened to the bolt portion 48, the holding plate 34 is pressed toward the pressure receiving plate 36. At this time, the four arm portions 42 are elastically deformed. The elastic force (spring force) of the four arm portions 42 is applied to the cell stack 12 as the tightening load via the pressure receiving plate 36. This tightening load is the holding force of the holding plate 34 with respect to the cell stack 12. The battery frame 16 holds the cell stack 12 solely by the frictional force generated by the force of the holding plate 34 pushing the cell stack 12 via the pressure receiving plate 36.

As shown in FIGS. 1 and 2, the battery module 10 further includes a fall-off prevention mechanism 60. The fall-off prevention mechanism 60 is a structure for preventing at least the heat exchanger 20 from falling off from the cell stack 12. The fall-off prevention mechanism 60 has a through-hole 62 and a shaft 64. In this embodiment, the fall-off prevention mechanisms 60 are respectively arranged at both end portions of the battery module 10 in the Y direction. That is, the battery module 10 includes a plurality of fall-off prevention mechanisms 60.

The through-hole 62 is a hole formed at a portion of the heat exchanger 20 that does not overlap the battery cells 18 in the stacking direction (X direction). Specifically, the through-hole 62 is formed at each of the water supply-drainage header 26 and the turn header 28 of the heat exchanger 20. In this embodiment, the through-hole 62 is also a positioning hole for determining the installation position of the cell stack 12. That is, when the battery module 10 is installed on an installation target (for example, the mobile object 100 shown in FIG. 6), a positioning shaft (not shown) is inserted into the through-hole 62 to position the cell stack 12. In this embodiment, the through-hole 62 is circular.

The through-hole 62 (hereinafter also referred to as “through-hole 62a”) formed at the water supply-drainage header 26 penetrates the water supply-drainage headers 26 in the stacking direction. The through-hole 62a is formed between the water supply port 30 and the drain port 32. The through-hole 62a is formed at a lower portion of the water supply-drainage header 26. The through-hole 62a may be formed at an upper portion of the water supply-drainage header 26 or in a central portion in the vertical direction of the water supply-drainage header 26.

The through-hole 62 (hereinafter also referred to as “through-hole 62b”) formed at the turn header 28 penetrate the turn header 28 in the stacking direction. The through-hole 62b is formed at a lower portion of the turn header 28. The through-hole 62b may be formed at an upper portion of the turn header 28 or in a central portion in the vertical direction of the turn header 28.

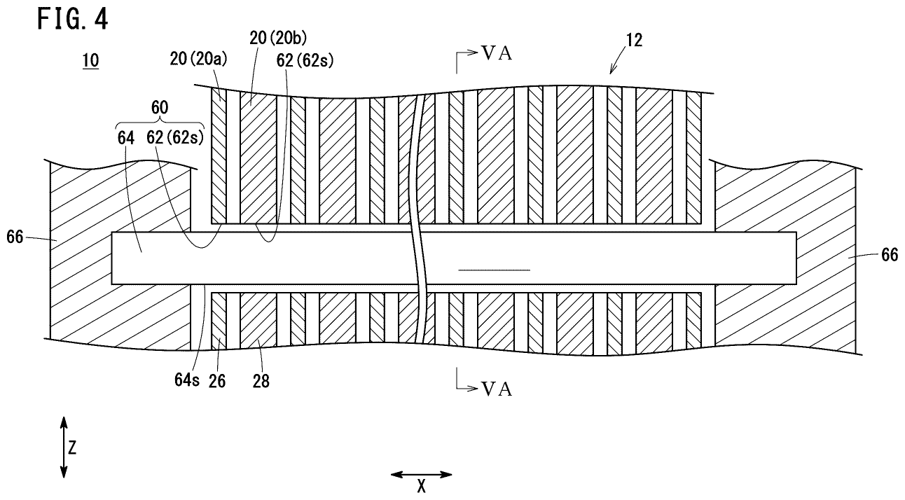

As shown in FIG. 4, at the fall-off prevention mechanism 60, a plurality of through-holes 62 are arranged on a straight line in the stacking direction (X direction). Therefore, a hole row is formed by a plurality of through-holes 62 arranged in the stacking direction.

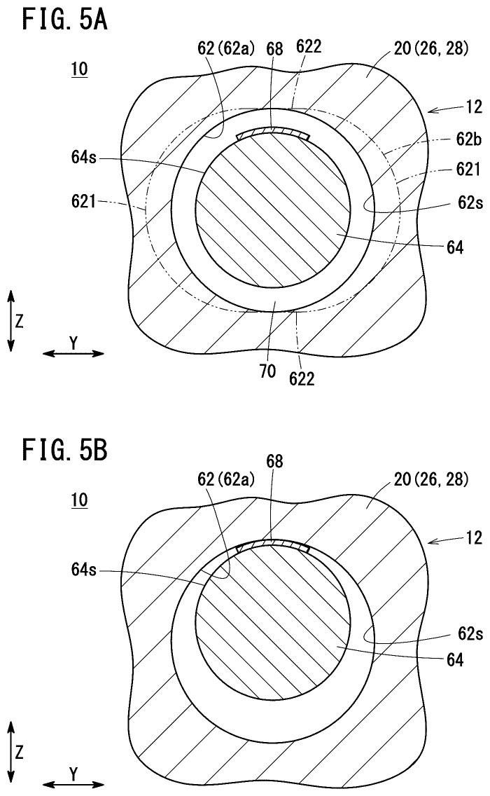

As shown in FIG. 5A, the through-hole 62a provided at the water supply-drainage header 26 is preferably circular. On the other hand, the through-hole 62b provided at the turn header 28 preferably has a shape of a track and field. That is, the through-hole 62a is preferably circular in shape because the through-hole 62a is arranged in a substantially fixed position by the water supply port 30. On the other hand, the through-hole 62b has preferably a track-and-field shape with a clearance in the Y direction with respect to the shaft 64 in consideration of the influence of the thermal elongation during use and the dimensional variation in the longitudinal direction (Y direction) of each water jacket 24 (FIG. 2). The track-and-field shape of the through-hole 62b is a shape having a pair of semicircular arc portions 621 and a pair of straight line portions 622 connecting the pair of arc portions 621. The long axis of the track-and-field shape of the through-hole 62b extends along the longitudinal direction of the water jacket 24 (FIG. 2). In this case, the radii of the plurality of through-holes 62a and the radii of the arc portions 621 of the track-and-field shapes of the plurality of through-holes 62b are all equal to each other. The hole shapes of the through-hole 62a and the through-hole 62b do not have to be the above-described shape but can be selected arbitrarily within the range in which the object of the present invention can be achieved. For example, the hole shapes of the through-hole 62a and the through-hole 62b can be an oval, a quadrilateral, or the like.

As shown in FIG. 4, the shaft 64 is inserted through the through-hole 62 (a hole row composed of a plurality of through-holes 62). The shaft 64 extends along the stacking direction of the cell stack 12. The heat exchanger 20 is movable in the stacking direction relative to the shaft 64. The shaft 64 is longer than the dimension of the cell stack 12 in the stacking direction. Thus, the opposite end portions of the shaft 64 project from the cell stack 12. The end portions of the shaft 64 are held by supports 66 that are placed on both sides of the stacking direction of the battery module 10. The shaft 64 prevents the heat exchanger 20 from falling off. That is, the shaft 64 is a fall-off prevention shaft.

The supports 66 are fixed to a floor of the installation target (for example, the mobile object 100 shown in FIG. 6) in which the battery module 10 is installed. The supports 66 support the opposite end portions of the shaft 64, thereby preventing the shaft 64 from moving in a direction orthogonal to the stacking direction (axial direction of the shaft 64).

As shown in FIG. 5A, the cross-sectional shape of the shaft 64 on a plane perpendicular to the axial direction of the shaft 64 is circular. The cross-sectional shape of the shaft 64 is not limited to a circular shape but may be, for example, an elliptical shape, a quadrilateral shape, or the like.

When the cell stack 12 maintains a state of being at an initial position that is the position at the beginning of pressing with respect to the pressing portion 35 (holding plate 34) of the holding mechanism 17 as shown in FIG. 1, the entire circumference of an outer peripheral surface 64s of the shaft 64 is apart from an inner peripheral surface 62s of the through-hole 62 as shown in FIG. 5A. That is, in the state where the heat exchanger 20 is not deviated from the initial position, an annular space 70 is formed between the outer peripheral surface 64s of the shaft 64 and the inner peripheral surface 62s of the through-hole 62, the annular space 70 surrounding the outer peripheral surface 64s of the shaft 64.

As shown in FIG. 5A, a substance for reducing a friction coefficient (hereinafter also referred to as “low-friction material 68”) may be provided on at least a part of the outer peripheral surface 64s of the shaft 64 or at least a part of the inner peripheral surface 62s of the through-hole 62. In this embodiment, the low-friction material 68 is provided at least on an upper part of the outer peripheral surface 64s of the shaft 64 or at least on an upper part of the inner peripheral surface 62s of the through-hole 62. When the low-friction material 68 is provided, the low-friction material 68 is provided on at least one of the outer peripheral surface 64s of the shaft 64 and the inner peripheral surface 62s of the through-hole 62. The low-friction material 68 may be provided on both the outer peripheral surface 64s of the shaft 64 and the inner peripheral surface 62s of the through-hole 62. Examples of the low-friction material 68 include coatings of fluorine-based resin, polyacetal, polyamide, and the like. The low-friction material 68 may be a lubricant such as grease.

According to the present embodiment, the following effects are obtained.

As shown in FIG. 1, the battery module 10 includes the fall-off prevention mechanism 60 that prevents at least the heat exchanger 20 from falling off the cell stack 12. According to such a configuration, even when the vibration beyond anticipation is applied to the battery module 10, the heat exchanger 20 is supported by the fall-off prevention mechanism 60 (the through-hole 62 and the shaft 64) as shown in FIG. 5B. This prevents the heat exchanger 20 from falling off the cell stack 12. In addition, because it is not necessary to increase the tightening force caused by the holding mechanism 17 (battery frame 16) shown in FIG. 1, it is possible to prevent the tightening force acting on the battery cell 18 from becoming too large when the battery cell 18 expands because of temperature rise or deterioration of the battery cell 18.

As shown in FIG. 1, the fall-off prevention mechanism 60 includes the through-hole 62 formed at a portion of the heat exchanger 20 that does not overlap the battery cells 18 in the stacking direction, and the shaft 64 inserted through the through-hole 62 and held at both ends. According to such a configuration, the heat exchanger 20 can be effectively prevented from falling off the cell stack 12 without affecting the battery cells 18.

The heat exchanger 20 is movable in the stacking direction relative to the shaft 64. Such a configuration can allow the heat exchanger 20 to move when the battery cell 18 expands because of heat generation or deterioration of the battery cell 18. Therefore, the tightening force acting on the battery cell 18 can be prevented from becoming too large.

When the cell stack 12 maintains a state of being at an initial position that is the position at the beginning of pressing with respect to the pressing portion 35, the entire circumference of the outer peripheral surface 64s of the shaft 64 is apart from the inner peripheral surface 62s of the through-hole 62 as shown in FIG. 5A. With such a configuration, as long as the cell stack 12 maintains the initial position, no sliding resistance is generated between the heat exchanger 20 and the shaft 64 when the battery cell 18 expands because of heat generation or deterioration of the battery cell 18 and the heat exchanger 20 moves with respect to the shaft 64. Thus, the movement of the heat exchanger 20 is not impeded, and the function of absorbing the expansion of the battery cell 18 is properly exhibited.

A substance for reducing the friction coefficient (low-friction material 68) is provided on at least a part of the outer peripheral surface 64s of the shaft 64 or at least a part of the inner peripheral surface 62s of the through-hole 62. According to such a configuration, when the heat exchanger 20 moves relative to the shaft 64 in the stacking direction with the inner peripheral surface 62s of the through-hole 62 being in contact with the outer peripheral surface 64s of the shaft 64, the sliding resistance between the heat exchanger 20 and the shaft 64 can be reduced when the heat exchanger 20 touches the outer peripheral surface 64s of the shaft 64 at the position of the low-friction material 68.

The low-friction material 68 is provided at least on the upper part of the outer peripheral surface 64s of the shaft 64 or at least on the upper part of the inner peripheral surface 62s of the through-hole 62. When the heat exchanger 20 is displaced downward because of an impact, the outer peripheral surface 64s of the shaft 64 and the inner peripheral surface 62s of the through-hole 62 come into contact with each other. Therefore, the sliding resistance between the heat exchanger 20 and the shaft 64 can be reduced when the heat exchanger 20 moves relative to the shaft 64 in the stacking direction. The low-friction material 68 may be omitted.

The through-hole 62 is a positioning hole for determining the installation position of the cell stack 12. According to such a configuration, the positioning hole can be used as the fall-off prevention hole as it is. This leads to a rationalized structure.

As shown in FIG. 2, the through-holes 62 are formed at each of a pair of headers (the water supply-drainage header 26 and the turn header 28) in the heat exchanger 20. According to such a configuration, it is possible to effectively prevent the heat exchanger 20 from falling off the cell stack 12 without increasing the number of components of the heat exchanger 20.

With respect to the above embodiments, the following supplementary notes are further disclosed.

### Supplementary Note 1

The battery module (10) of the present disclosure includes the cell stack (12) that includes the battery cell (18) and the heat exchanger (20) stacked on the battery cell, the holding mechanism (17) that holds the cell stack by pressing both stacking-direction end portions of the cell stack inward in the stacking direction, and the fall-off prevention mechanism (60) that prevents at least the heat exchanger from falling off the cell stack.

### Supplementary note 2

Regarding the battery module according to Supplementary note 1, the fall-off prevention mechanism may include the through-hole (62) that is formed at a portion of the heat exchanger that does not overlap the battery cell in the stacking direction, and the shaft (64) that is inserted through the through-hole and held at both ends, and the shaft may prevent the heat exchanger from falling off.

### Supplementary Note 3

Regarding the battery module according to Supplementary note 2, the shaft may extend in the stacking direction, and the heat exchanger is movable relative to the shaft in the stacking direction.

### Supplementary Note 4

Regarding the battery module according to Supplementary note 3, the holding mechanism may include the pressing portion (35) that presses the cell stack, and the entire periphery of the outer peripheral surface (64s) of the shaft may be apart from the inner peripheral surface (62s) of the through-hole in a case where the cell stack maintains a state of being at an initial position that is a position at the beginning of pressing with respect to the pressing portion.

### Supplementary Note 5

Regarding the battery module according to Supplementary note 3, a substance for reducing a friction coefficient may be provided on at least a part of an outer peripheral surface of the shaft or at least a part of an inner peripheral surface of the through-hole.

### Supplementary Note 6

Regarding the battery module according to Supplementary note 5, the substance may be provided at least on the upper part of the outer peripheral surface of the shaft or at least on the upper part of the inner peripheral surface of the through-hole.

### Supplementary Note 7

Regarding the battery module according to Supplementary note 2, the through-hole may be a positioning hole for determining the installation position of the cell stack.

### Supplementary Note 8

Regarding the battery module according to Supplementary note 2, the pair of headers are provided at both end portions of the heat exchanger in the horizontal direction orthogonal to the stacking direction, and the through-hole may be formed at each of the pair of headers.

### Supplementary Note 9

Regarding the battery module according to any one of Supplementary notes 2 to 8, the heat exchanger may include the water jacket (24) that extends in one direction, the water supply port (30) and the water drain port (32) that are provided at the first end portion that is one end portion in the longitudinal direction of the water jacket, and the turn header (28) that is provided at the second end portion that is another end portion in the longitudinal direction of the water jacket, and the turn header may receive cooling water from the forward flow path of the water jacket and allows the cooling water to flow to the return flow path of the water jacket, the through-hole provided at the first end portion may be circular, and the through-hole provided at the second end portion may have a track-and-field shape with a long axis extending along the longitudinal direction of the water jacket.

### Supplementary Note 10

Regarding the battery module according to Supplementary note 9, the radius of the through-hole provided at the first end portion and the radius of the semicircular arc portion (621) of the through-hole provided at the second end portion may be substantially equal.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A battery module comprising:
a cell stack that includes a battery cell and a heat exchanger stacked on the battery cell;
a holding mechanism that holds the cell stack by pressing both stacking-direction end portions of the cell stack inward in a stacking direction; and
a fall-off prevention mechanism that prevents at least the heat exchanger from falling off the cell stack.

2. The battery module according to claim 1, wherein
the fall-off prevention mechanism includes:
a through-hole that is formed at a portion of the heat exchanger that does not overlap the battery cell in the stacking direction; and
a shaft that is inserted through the through-hole and held at both ends, and
the shaft prevents the heat exchanger from falling off.

3. The battery module according to claim 2, wherein
the shaft extends in the stacking direction, and
the heat exchanger is movable relative to the shaft in the stacking direction.

4. The battery module according to claim 3, wherein
the holding mechanism includes a pressing portion that presses the cell stack, and
an entire periphery of an outer peripheral surface of the shaft is apart from an inner peripheral surface of the through-hole in a case where the cell stack maintains a state of being at an initial position that is a position at a beginning of pressing with respect to the pressing portion.

5. The battery module according to claim 3, wherein
a substance for reducing a friction coefficient is provided on at least a part of an outer peripheral surface of the shaft or at least a part of an inner peripheral surface of the through-hole.

6. The battery module according to claim 5, wherein
the substance is provided on at least an upper part of the outer peripheral surface of the shaft or on at least an upper part of the inner peripheral surface of the through-hole.

7. The battery module according to claim 2, wherein
the through-hole is a positioning hole for determining an installation position of the cell stack.

8. The battery module according to claim 2, wherein
a pair of headers are provided at both end portions of the heat exchanger in a horizontal direction orthogonal to the stacking direction, and the through-hole is formed at each of the pair of headers.

9. The battery module according to claim 2, wherein
the heat exchanger includes:
a water jacket that extends in one direction;
a water supply port and a water drain port that are provided at a first end portion that is one end portion of the water jacket in a longitudinal direction; and
a turn header that is provided at a second end portion that is another end portion in the longitudinal direction of the water jacket,
the turn header receives cooling water from a forward flow path of the water jacket and allows the cooling water to flow to a return flow path of the water jacket,
the through-hole provided at the first end portion is circular, and
the through-hole provided at the second end portion has a track-and-field shape with a long axis extending along the longitudinal direction of the water jacket.

10. The battery module according to claim 9, wherein
a radius of the through-hole provided at the first end portion and a radius of a semicircular arc portion of the through-hole provided at the second end portion are substantially equal.
